(19) United States
(12) Patent Application Publication
(10) Pub. No.: US 2011/0248777 A1
(43) Pub. Date: Oct. 13, 2011

(54) SEMICONDUCTOR CHIP WITH VOLTAGE ADJUSTABLE FUNCTION AND MANUFACTURE METHOD THEREOF

(75) Inventor: Shuang Xu, Shenzhen (CN)

(73) Assignee: NVIDIA Corporation, Santa Clara, CA (US)

(21) Appl. No.: 13/084,480

(22) Filed: Apr. 11, 2011

(30) Foreign Application Priority Data
Apr. 12, 2010 (CN) 201010144807.4

(51) Int. Cl. G05F 1/10; H01S 4/00

(52) U.S. Cl. 327/540; 29/592.1

(57) ABSTRACT

The present invention provides a semiconductor chip with voltage adjustable function, said semiconductor chip is supplied with a power supply device and comprises a voltage regulating module for adjusting the voltage supplied to said semiconductor chip from said power supply device, based on the best operating voltage at which said semiconductor chip operates.

### CLAIM OF PRIORITY

The present application claims the priority of Chinese Patent Application No. 201010144807.4, filed April 12, 2010, which is incorporated herein by reference.

### FIELD OF INVENTION

The present invention relates to semiconductor chips, and more particularly to GPU chips and manufacture method thereof.

### BACKGROUND

In a computer, a display system usually has a monitor as well as a graphics processing device in order to process and display a lot of image data at a high speed. Graphics processing device often consists of a graphics processing unit (GPU) which is dedicated to image processing, Video Random Access Memory (VRAM) which is used to store image data as a storage device and display processing device etc. Herein the display system denotes a kind of system which has the function of explaining and processing the computation instructions executed in a central processing unit and displaying graphics. Furthermore, a display processing device denotes a kind of device which receives computation instructions executed in GPU and forms the image data which will be sent to the display device in the display system. Furthermore, a display processing device denotes a kind of device which displays the image data formed in a display processing device as the image in a displaying section. A displaying section denotes an area which consists of many pixels and is used to display images therein.

GPU is a concept which is relative to CPU. It could support in hardware the image displaying hardware of polygon converting and light source disposing. Recently, the main computations executed in GPU include mask computing, depth detecting and rasterization. Because GPU adopts a processor design mode of single-instruction and multiple-date and it does not need to make memory management and respond to the input and output of the system, the performance of the image processing of GPU is far more quickly than the CPU. As a result, GPU gradually becomes an indispensable part of the computer and the requirements on the performance of GPU chip becomes higher and higher.

Generally, however, there will be some differences between the chips manufactured in the same lot, which may be caused by the process bias in production process, such as the mask misalignment in lithography procedure, film deposition procedure and the bias of thickness control of film in CMP procedure, even in the same structure of different chips which belong to not only the different wafer but also the same ones in a semiconductor integrated circuit chip progress. Therefore, there will be some differences in performance parameters between the GPU chips due to the bias, although all of the parameters fall into a tolerant range. For example, a voltage of 0.9V is the best operating voltage for some GPU chips but for others may be 1V. However, when a GPU is installed into a graphics card and provided with a power supply, since the voltage output from the power supply is usually constant for different GPU chips, not every GPU chips can operate at its best operating condition due to the different power supply.

Therefore, there is a need for a kind of GPU chip and a method of providing voltage for the GPU chip in order to solve the problem that most of GPU chips cannot work at its best operating condition because of the same operating voltage provided for each GPU chip in prior art.

### SUMMARY

This summary is provided to introduce a selection of concepts in a simplified form that are further described below in the Detailed Description. This summary is not intended to identify key features or essential features of the claimed subject matter, nor is it intended to be used as an aid in determining: the scope of the claimed subject matter.

The present invention provides a semiconductor chip with voltage adjustable function, said semiconductor chip is supplied with a power supply device and comprises a voltage regulating module for adjusting the voltage supplied to said semiconductor chip from said power supply device, based on the best operating voltage at which said semiconductor chip operates.

According to another aspect of the present invention, it provides a method of manufacturing a semiconductor chip with voltage adjustable function, comprises steps of a. providing a semiconductor chip, said semiconductor chip is supplied with a power supply device and comprises a voltage regulating module for adjusting the voltage supplied to said semiconductor chip from said power supply device, based on the best operating voltage at which said semiconductor chip operates; b. determining the best operating voltage at which said semiconductor chip operates; c. regulating the output signal from said voltage regulating module; and d. packaging said semiconductor chip.

Other features and embodiments are described below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows the block diagram of a semiconductor chip with voltage adjustable function according to the present invention;

FIG. 2 is a block diagram of a GPU chip with voltage adjustable function according to an embodiment of the present invention;

FIG. 3A is a block diagram of a GPU chip with a resistor-fuse array according to one embodiment of the present invention;

FIG. 3B is a block diagram of a GPU chip with a resistor-fuse array according to another embodiment of the present invention;

FIG. 3C is a block diagram of a GPU chip with a resistor-fuse array according to another embodiment of the, presents invention;

FIGS. 4 is a flow process chart for manufacturing a GPU chip with voltage adjustable function according to the embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, certain well-known features have not been described in order to avoid obscuring the present invention.

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means, generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not, necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying”, “accessing”, “writing”, “including”, “storing”, “transmitting”, “traversing”, “associating”, “identifying” or the like, refer to the action and processes of a computer system, or similar processing device (e. g. , an electrical, optical, or quantum, computing device), that manipulates and transforms data represented as physical (e. g. , electronic) quantities. The terms refer to actions and processes of the processing devices that manipulate or transform physical quantities within a computer system's component (e. g., registers, memories, other such information storage, transmission or display devices, etc.) into other data similarly represented as physical quantities within other components.

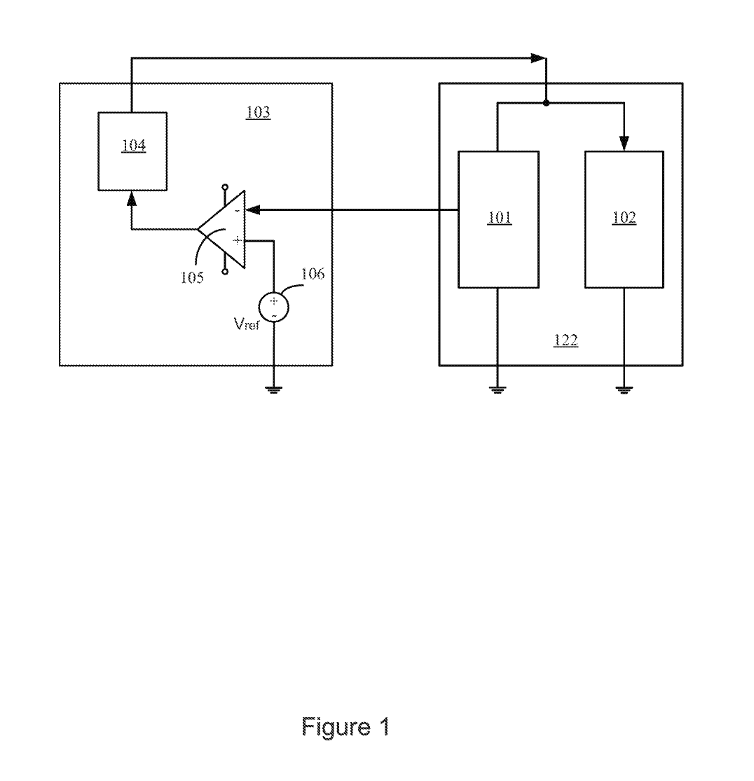

FIG. 1 shows the block diagram of a semiconductor chip with voltage adjustable function according to the present invention. The block diagrams in the present invention are just for the purpose of illustration and not intended to limit the scopes of claims as followings.

As shown in FIG. 1, a GPU 122 is provided. GPU 122 includes a voltage regulating module 101 and an equivalent load module 102. The equivalent load module 102 herein refers to the total equivalent loads of all the components in GPU 122 during operation. GPU 122 is supplied with a power supply module 103. The power supply module 103 may be any power supply devices well known to those skilled in the art, which has a feedback function for supplying GPUs. For example, the power supply module 103 comprises an operational amplifier whose in-phase input is connected with a reference voltage source, and the anti-phase input receives a signal input from said voltage regulating module, and a feedback module 104 for receiving the output of the operational amplifier as its input and outputting a voltage signal to supply CPUs. The feedback module may comprises a multi-level amplify circuit consisting of transistors, which will be not shown in details.

According to the present invention, the voltage regulating module 101 will be adjusted based on the parameters such as the best operating voltage and temperature for every single GPU, and then the signal input to the in-phase input of the operational amplifier may be adjusted, which will in turn change the output signal from the operational amplifier. Therefore, the adjusted signal (voltage) will be supplied to GPU 122 via the feedback module 104, so as to provide the best operating voltage for GPU 122. In this way, GPU 122 may operate in its best operating state.

### Exemplary Embodiment 1

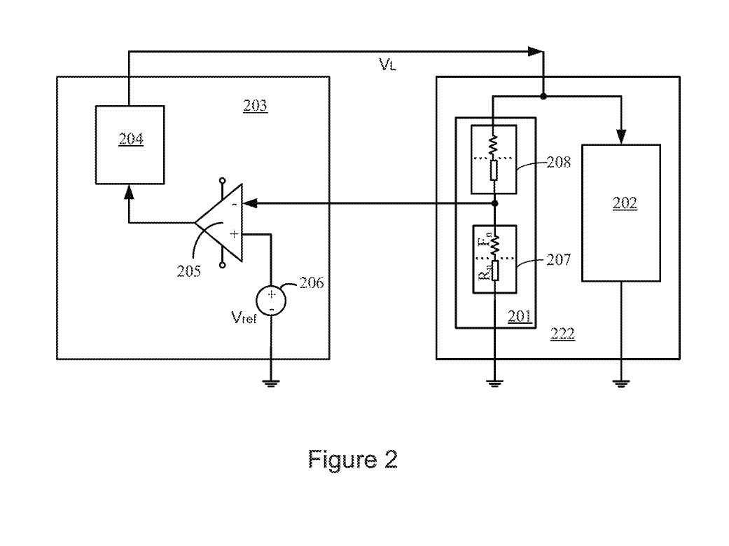

FIG. 2 is a block diagram of a GPU chip with voltage adjustable function according to an embodiment of the present invention. As shown in FIG. 2, a GPU 222 is provided which includes a voltage regulating module 201 and an equivalent load module 202. The equivalent load module 202 herein refers to the total equivalent loads of all the components in GPU 222 during operation. A power supply module 203 provides operating voltages for GPU 222. The power supply module 203 could be any modules well known to those skilled in the art in order to provide voltage for GPU 222. For example, the power supply module 203 comprises a feedback module 204, an operational amplifier 205 and a reference voltage source 206. The voltage regulating module 201 is used to provide the best operating voltage for GPU 222 in order to make the GPU 222 work at the best operating condition.

Specifically, the voltage regulating module 201 includes a first voltage regulating module 207 and a second voltage regulating module 208. The in-phase end of the operational amplifier 205 connects to the reference voltage source 206 and the anti-phase end thereof connects to the connection point between the first voltage regulating module 207 and the second voltage regulating module 208 for receiving an input signal adjusted by the voltage regulating module 201. One end of the first voltage regulating module 207 is grounded, and the other end connects to the anti-phase end of the operational amplifier 205. One end of the second voltage regulating module 208 connects to the end of the first voltage regulating module 207 which connects to the anti-phase end of the operational amplifier 205 and the other end thereof connects to the feedback module 204. The input of the feedback module 204 connects with the output of the operational amplifier 205, and the signal output from the operational amplifier 205 is converted to the voltage input signal for GPU 222, which will be input to the equivalent load module 202 to supply to GPU 222. One end of the equivalent load module 202 is grounded.

The first voltage regulating module 207 and the second voltage regulating module 208 may be implemented with an array of a plurality of resistors in parallel connections. There is a fuse Fₙ which is connected in series with each Rₙ respectively in order to control whether the Rₙ is in use or not. The material of the fuse includes but is not limited in lead-antimony alloy, copper alloy or silver alloy. Herein n is integer and n≧1. The array of resistors and fuses may include sub-arrays with a combination of serial and parallel connections. The number of Rₙ which belongs to the first voltage regulating module and second voltage regulating module respectively could be optional, for example, from 1˜8. The resistance value of Rₙ could be from 1000 to 20000 ohm, such as 2000 ohm, 4000 ohm, 8000 ohm and 16000 ohm.

Based on a computation considering the best operating voltage for GPU 222, it will be determined which fuse or fuses should be selected to break. For example, when the equivalent resistance value of the first voltage regulating module 207 is R₁, the equivalent resistance value of the second voltage regulating module 208 is R₂ (here, the equivalent resistance value means the sum of the resistance of all the remaining resistors), the voltage provided by reference voltage source 206 is V_{ref,} and the best operating voltage of equivalent load module 202 is V_{L}, then the ration of R₁ and R₂ is selected according to the equation as below to make the voltage supplied to the equivalent load module 202 from the feedback module 204 equal to V_{L}, which means GPU 222 will operate at its best operating voltage V_{L}.

V_{ref}/V_{L}=R₁/(R₁+R₂) (1)

Herein R₁ and R₂ are not necessary to be assigned with a specific value. A ratio that can meet the equation (1) is sufficient.

### Exemplary Embodiment 2

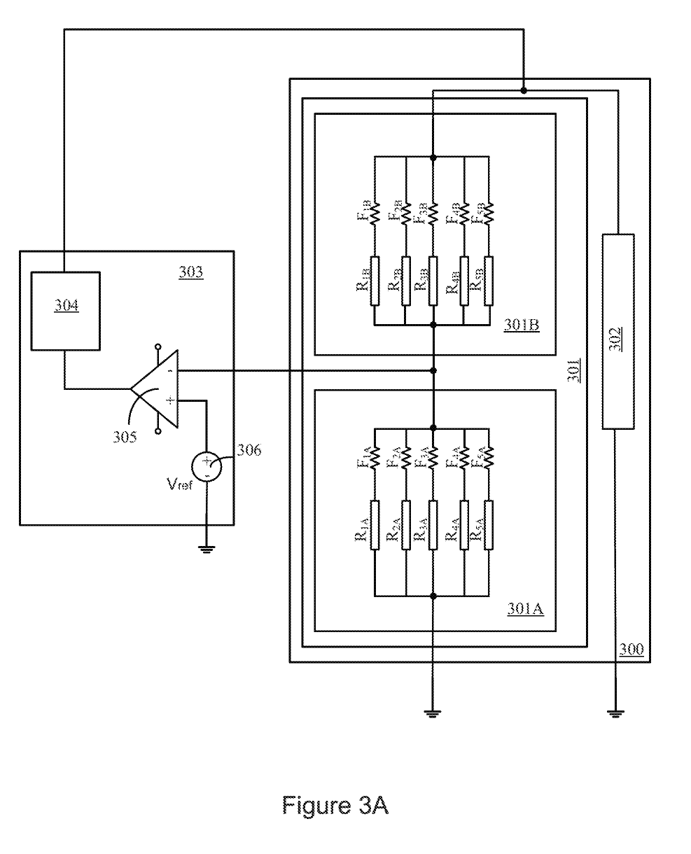

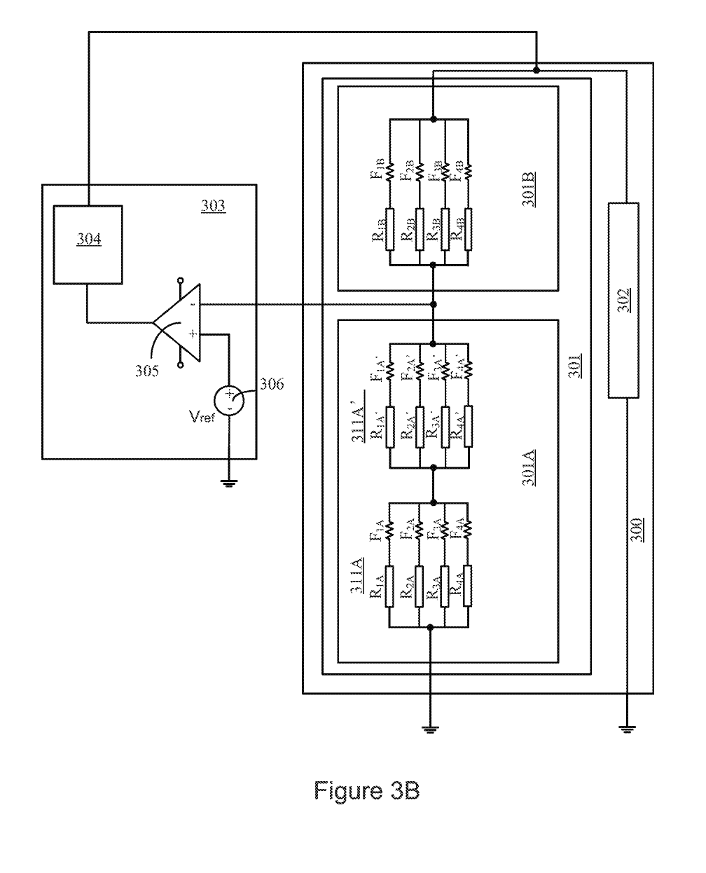

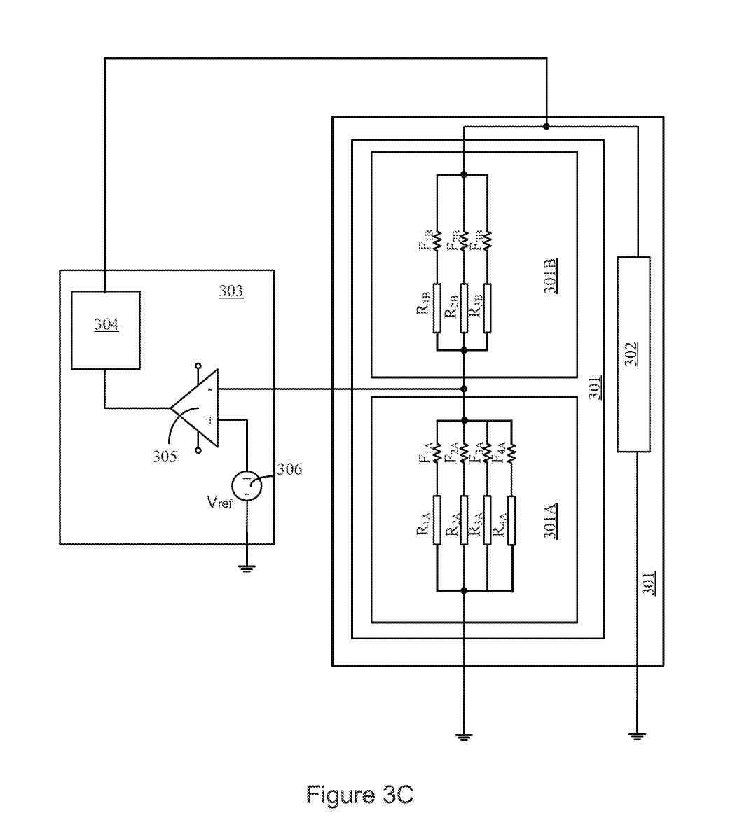

FIG. 3A is a block diagram of a GPU chip with a resistor-fuse array according to one embodiment of the present invention. As shown in FIG. 3A, a GPU 300 is provided, which includes a voltage regulating module 301 and a equivalent load module 302. A power supply module 303 provides voltage for GPU 300. The power supply module 303 could be any form well known to persons skilled in the art in order to provide voltage for GPU 300, for example, including a feedback module 304, an operational amplifier 305 and a reference voltage source 306. The voltage regulating module 301 includes a first voltage regulating module 301A and a second voltage regulating module 301B. One end of the first voltage regulating module 301A is grounded and the other end of the first voltage regulating module 301A connects to the anti-phase end of operational amplifier 305; one end of the second voltage regulating module 301B connects to the anti-phase of the operational amplifier 305, the other end connects to the feedback module 304; one end of the load module 302 connects to the feedback module 304 and the other end is grounded.

The first voltage regulating module 301A has five resistors which are in parallel connection, such as R_{1A} of 1000 ohm, R_{2A} of 2000 ohm, R_{3A} of 4000 ohm, R_{4A} of 8000 ohm and R_{5A} of 16000 ohm. Also, the second voltage regulating module 301B has five resistors which are in parallel connection, such as R_{1B} of 1000 ohm, R_{2B} of 2000 ohm, R_{3B} of 4000 ohm, R_{4B} of 8000 ohm and R_{5B} of 16000 ohm. Each resistor has a fuse connected with it. A Fuse F_{1A} is connected in series with R_{1A}, a fuse F_{2A} is connected in series with R_{2A}, a fuse F_{3A} is connected in series with R_{3A}, a fuse F_{4A} is connected in series with R_{4A} and a fuse F_{5A} is connected in series with R_{5A}. The forth level partial voltage 312 also has the fuse F_{1B}, F_{2B}, F_{3B}, F_{4B} and F_{5B} which is connected in series with R_{1B}, R_{2B}, R_{3B}, R_{4B} and R_{5B} respectively. Some fuses of voltage regulating module 301 will be broken when the best operating condition for GPU is determined, in order to get a proper resistance value ratio which could guarantee to provide the best operating voltage for the GPU. An example is that when the reference voltage source in the power supply module 303 is 0.8V and the best operating voltage of GPU chip is 1V, it needs R_{first}/(R_{first}+R_{second})=0.8/1=0.8, so the F_{1A}, F_{2A}, F_{3A} and F_{5A} of the first voltage regulating module 301A will be broken, and R_{4A} of 8000 ohm remains. F_{1B}, F_{2B}, F_{3B} and F_{5B} of the second voltage regulating module 301B are broken and R_{2B} of 2000 ohm remains.

### Exemplary Embodiment 3

Another embodiment according to the present invention is shown in FIG. 3B. In Figure 3B, an array of resistor-fuse connected in a manner of combination of serial and parallel connections is adopted. A GPU 300 is provided which includes a voltage regulating module 301 and a load module 302. A power supply module 303 provides voltage for GPU 300. The power supply module 303 could be any form well known to persons skilled in the art in order to provide voltage for GPU 300, for example, including a feedback module 304, an operational amplifier 305 and a reference voltage source 306. The voltage regulating module 301. includes a first voltage regulating module 301A and a second voltage regulating module 301B. The first voltage regulating module 301A includes two arrays of resistor-fuse 311A, 311A′ which are in series with each other. One end of the first voltage regulating module 301A is grounded and the other end of the first voltage regulating module 301A connects to the anti-phase end of operational amplifier 305; one end of the second voltage regulating module 301B connects to the end of the anti-phase of the operational amplifier 305, the other end connects to the feedback module 304; one end of load module 302 connects to the feedback module 304 and the other end is grounded. The arrays of resistor-fuse 311A has four resistors, R_{1A}, R_{2A}, R_{3A} and R_{4A,} which are in parallel with each other and fuse F_{1A} is connected in series with R_{1A}, fuse F_{2A} is connected in series with R_{2A}, fuse F_{3A} is connected in series with R_{3A} and fuse F_{4A} is connected in series with R_{4A} respectively. The arrays of resistor-fuse 311A′ has four resistors, R_{1A′}, R_{2A′}, R_{3A′} and R_{4A′}, which are in parallel with each other and fuse. F_{1A′} is connected in series with R_{1A′}, fuse F_{2A′} is connected in series with R_{2A′}, fuse F_{3A′} is connected in series with R_{3A′} and fuse F_{4A′} is connected in series with R_{4A′} respectively. The resistances of the resistors in array 311A and 311A′ may be chosen to be identical or difference from each other as needed. The second voltage regulating module 301B has four resistors, R_{1B}, R_{2B,} R_{3B} and R_{4B,} which are in parallel with each other and fuse F_{1B} is connected in series with R_{1B}, fuse F_{2B} is connected in series with R₂₁₃, fuse F_{3B} is connected in series with R_{3B} and fuse R_{4B} is connected in series with R_{4B}. The resistor selection is similar to the embodiment shown in FIG. 3A, and will be not illustrated in details. Compared with the embodiment of FIG. 3A, however, in the embodiment as shown in FIG. 3B, the total equivalent of resistance in the first voltage regulating module 301A will be the sum of the selected resistor(s) in the array 311A and 311A′. In this way, a finer ration of R_{first}/(R_{first}+R_{second}) may be obtained by dividing the first voltage regulating module 301A into two arrays 311A and 311A′.

### Exemplary Embodiment 4

Another implement scheme according to present invention is shown in FIG. 3C. In FIG. 3C, the number of the resistors in the first voltage regulating module may be different from the number of the resistors in the second voltage regulating module, as long as a suitable ratio of the resistance may be obtained. A GPU 300 is provided, which includes a voltage regulating module 301 and a load module 302. The external power supply module 303 provides voltage for GPU 300. The power supply module 303 could be any form well known to persons skilled in the art in order to provide voltage for GPU 300, for example, including a feedback module 304, an operational amplifier 305 and a reference voltage source 306. The voltage regulating module includes a first voltage regulating module 301A and a second voltage regulating module 301B. One end of the first voltage regulating module 301A is grounded and the other end of the first voltage regulating module 301A connects to the anti-phase end of operational amplifier 305; one end of the second voltage regulating module 301B connects to the anti-phase end of the operational amplifier 305, the other end connects to the feedback module 304; one end of the load module 302 connects to the feedback module 304 and the other end is grounded. The first voltage regulating module 301A has four resistors, R_{1A,} R_{2A,} R_{3A} and R_{4A,} which are in parallel with each other and fuse F_{1A} is connected in series with R_{1A}, fuse F_{2A} is connected in series with R_{2A}, fuse F_{3A} is connected in series with R_{3A} and fuse F_{4A} is connected in series with R_{4A}. The second voltage regulating module 301B has three resistors, R_{1B,} R_{2B} and R_{3A,} which are in parallel with each other and fuse F_{1B} is connected in series with R_{1B}, fuse F_{2B} is connected in series with R_{2B}, fuse F_{3B} is connected in series with R_{3B} respectively. The resistor selection is similar to the embodiment shown in FIG. 3A, and will be not illustrated in details.

The breaking of the resistors is performed during the testing of GPUs before the packaging. To detect the GPU chip before packaging it in order to define the voltage provided upon the best operating condition. The method begins with a step of applying a GPU with the highest voltage that it can endure, and decreasing the voltage at a certain step from said highest voltage which the GPU could endure, until GPU enters a state of instability, and then determining the last voltage at which GPU can operate stably as the best operating voltage. For example, if target frequency of the GPU chip is 600 MHz at the GPU chip testing phase, then run a specific test vectors with the frequency of 630 MHz in order to have 5% margin. Decreasing the testing voltage at 0.025V step from the highest voltage which the GPU chip could endure until GPU chip could not operate stably. To define the last voltage which could maintain the GPU chip operate stably as the best operating voltage. Then some fuses of voltage regulating module are broken according to the best operating voltage.

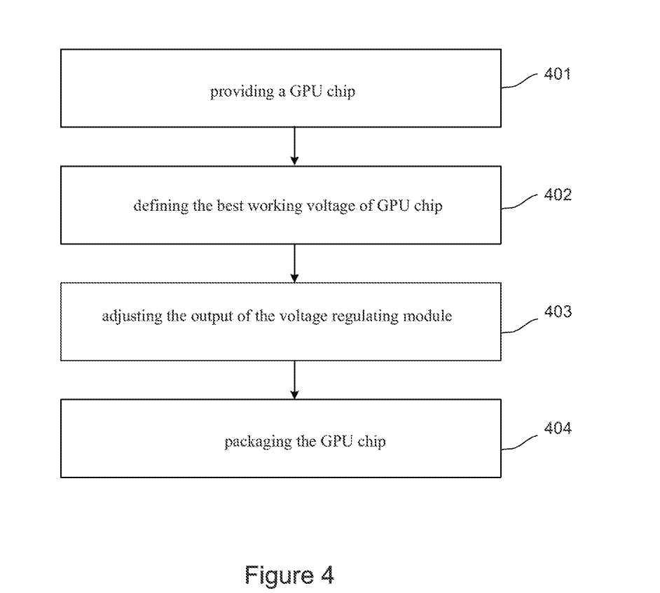

FIG. 4 is a flow process chart for GPU chips which could work at the best operating condition according to the embodiment of present invention. In step 401, providing a GPU chip which includes a first voltage regulating module and a second voltage regulating module. The first voltage regulating module includes at least one third level voltage regulating module and the second voltage regulating module includes at least one second voltage regulating module 301B; both the third level voltage regulating module and the forth level voltage regulating module consist of a number of resistors which are in parallel with each other and the fuse is connected in series with corresponding resistor. In step 402, defining the best operating voltage of GPU chip. In step 403, breaking some fuses in order to get the resistance value which is used to provide the best operating voltage for GPU chip. In step 404, the GPU chip is packaged.

It will be obvious for those skilled in the art that the present invention is not limited to apply in regulating a best operation voltage for GPU chips. Any semiconductors which may have differences in the parameters due to the process may adopt the method described in the present invention, in order to make the chips work at its best condition.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application to thereby enable others skilled in the art to best utilize the invention and various embodiments with various modifications as are suited to the particular use are contemplated. The scope of the invention is to be defined by the claims appended hereto and their equivalents.

What is claimed is:

1. A semiconductor chip with voltage adjustable function, said semiconductor chip is supplied with a power supply device and comprises
a voltage regulating module for adjusting the voltage supplied to said semiconductor chip from said power supply device, based on the best operating voltage at which said semiconductor chip operates.

2. The semiconductor chip of claim 1, wherein said semiconductor chip is a Graphics Processing Unit.

3. The semiconductor chip of claim 1, wherein said power supply device comprises
an operational amplifier, the in-phase input of said operational amplifier being connected with a reference voltage source, and the anti-phase input of said operational amplifier receiving a signal input from said voltage regulating module, and
a feedback module for receiving the output of said operational amplifier as its input and outputting a voltage signal to supply said semiconductor chip.

4. The semiconductor, chip of claim 3, wherein said voltage regulating module comprises a first voltage regulating module and a second voltage regulating module.

5. The semiconductor chip of claim 4, wherein said first voltage regulating module comprises a first set of a plurality of resistors in, series, parallel or series-parallel connection, and said second voltage regulating module comprises a second set of a plurality of resistors in series, parallel or series-parallel connection, each of said resistor haying a fuse connected with in series.

6. The semiconductor chip of claim 5, wherein the number of said first set of resistors is same as the number of said second set of resistors.

7. The semiconductor chip of claim 5, wherein the number of said first set of resistors is different from the number of said second set of resistors.

8. The semiconductor chip of claim 5, wherein the resistance of said resistors is selected from a group consisting of 1000 ohm, 2000 ohm, 4000 ohm, 8000 ohm and 16000 ohm.

9. The semiconductor chip of claim 5, wherein when the best operation voltage of said semiconductor chip is defined as V_{L}, the equivalent resistance R₁ of said first set of resistors and the equivalent resistance R₂ of said second set of resistors are selected according to
V_{ref}/V_{L}=R₁/(R₁+R₂)
wherein V_{ref} denotes the voltage of said reference voltage source.

10. The semiconductor chip of claim 9, wherein said equivalent resistance is achieved by breaking a part of the fuses connected with the resistors in said first and second set of resistors.

11. A method of manufacturing a semiconductor chip with voltage adjustable function, comprises steps of
a. providing a semiconductor chip, said semiconductor chip is supplied with a power supply device and comprises a voltage regulating module for adjusting the voltage supplied to said semiconductor chip from said power supply device, based on the best operating voltage at which said semiconductor chip operates;
b. determining the best operating voltage at which said semiconductor chip operates;
c. regulating the output signal from said voltage regulating module; and
d. packaging said semiconductor chip.

12. The method of claim 11, wherein said semiconductor chip is a Graphics Processing Unit.

13. The method of claim 11, wherein said power supply device comprises
an operational amplifier, the in-phase input of said operational amplifier being connected with a reference voltage source, and the anti-phase input of said operational amplifier receiving a signal input from said voltage regulating module, and
a feedback module for receiving the output of said operational amplifier as its input and outputting a voltage signal to supply said semiconductor chip.

14. The method of claim 13, wherein said voltage regulating module comprises a first voltage regulating module and a second voltage regulating module.

15. The method of claim 14, wherein said first voltage regulating module comprises a first set of a plurality of resistors in series, parallel or series-parallel connection, and said second voltage regulating module comprises a second set of a plurality of resistors in series, parallel or series-parallel connection, each of said resistor having a fuse connected with in series.

16. The method of claim 11, wherein the step of determining the best operating voltage at which said semiconductor chip operates comprises
applying said semiconductor chip with the highest voltage that it can endure;
decreasing said voltage at a certain step from said highest voltage which the semiconductor chip could endure, until said semiconductor chip enters a state of instability;
determining the last voltage at which said semiconductor chip can operate stably as the best operating voltage.

17. The method of claim, 15, wherein, the number of said first set of resistors is same as or different from the number of said second set of resistors.

18. The method of claim 15, wherein the resistance of said resistors is selected from a group consisting of 1000 ohm, 2000 ohm, 4000 ohm, 8000 ohm and 16000 ohm.

19. The method of claim 15, wherein when the best operation voltage of said semiconductor chip is defined as V_{L}, the equivalent resistance R₁ of said first set of resistors and the equivalent resistance R₂ of said second set of resistors are selected according to
V_{ref}/V_{L}=R₁/(R₁+R₂)
wherein V_{ref} denotes the voltage of said reference voltage source.

20. The method of claim 19, wherein said equivalent resistance is achieved by breaking a part of the fuses connected with the resistors in said first and second set of resistors.
